(19) United States
(12) Patent Application Publication
(10) Pub. No.: US 2025/0341704 A1
(43) Pub. Date: Nov. 6, 2025

(54) OPTICAL IMAGING LENS ASSEMBLY

(71) Applicant: ZHEJIANG SUNNY OPTICS CO., LTD., Ningbo City (CN)

(72) Inventors: Min YANG, Ningbo City (CN); Yongxian HE, Ningbo City (CN); Litong SONG, Ningbo City (CN); Weifang LI, Ningbo City (CN); Lin HUANG, Ningbo City (CN); Yinfang JIN, Ningbo City (CN); Liefeng ZHAO, Ningbo City (CN)

(73) Assignee: ZHEJIANG SUNNY OPTICS CO., LTD., Ningbo City (CN)

(21) Appl. No.: 19/266,399

(22) Filed: Jul. 11, 2025

(30) Foreign Application Priority Data
Dec. 25, 2024 (CN) 202411929583.6

(51) Int. Cl. G02B 9/62; G02B 7/02; G02B 13/00; G03B 13/36

(52) U.S. Cl. CPC G02B 9/62; G02B 7/021; G02B 13/0045; G03B 13/36

(57) ABSTRACT

An optical imaging lens assembly. The optical imaging lens assembly includes a lens cone, and a lens group and a spacing element group, which are arranged in the lens cone. The lens group sequentially includes from an object side to an image side along an optical axis: a first lens with a negative refractive power, a second lens with a refractive power, a third lens with a refractive power, a fourth lens with a refractive power, a fifth lens with a refractive power and a sixth lens with a negative refractive power. Image-side surfaces of the second lens, the third lens and the fifth lens are all convex surfaces. An object-side and image-side surface of the fourth lens are both convex or concave surfaces. The spacing element group includes a first spacing element. The optical imaging lens assembly satisfies: −3.45<R1/f<2.75 and 0.75<2×Yc11/d1s<1.25.

### CROSS-REFERENCE TO RELATED APPLICATIONS

The disclosure claims the priority to Chinese Patent Application No. 202411929583.6, filed with the China National Intellectual Property Administration (CNIPA) on Dec. 25, 2024, which is hereby incorporated by reference in its entirety.

### TECHNICAL FIELD

The disclosure relates to the technical field of optical elements, and in particularly to an optical imaging lens assembly.

### BACKGROUND

With the innovation of science and technology, consumer electronic devices such as mobile phones and tablets are being updated and iterated at an accelerated pace, and the market has increasingly high requirements for product-end optical lenses, which not only requires imaging lenses to have high pixels, large image surfaces and large viewing angles, but also requires the imaging lenses to have smaller mechanical dimensions to satisfy the requirement of electronic designs to acquire greater screen-to-body ratios.

In an existing six-piece optical imaging lens assembly, in order to achieve the design of a wide-angle optical system, a first lens is usually set to have a negative refractive power, and the position of an inflection point of which has a greater impact on the performance of an MTF (modulation transfer function), when the inflection point is too close to an optical axis, a curvature offset of an external field of view becomes severe, and when the inflection point is too close to a maximum effective radius of the first lens, the external field of view is intercepted more, resulting in image blurring. Therefore, how to design a lens that can not only implement a large viewing angle but also can reduce an edge field-of-view performance risk to the greatest extent is one of contradictions to be solved by those skilled in the art.

### SUMMARY

Some embodiments of the disclosure provide such an optical imaging lens assembly. The optical imaging lens assembly includes: a lens cone, and a lens group and a spacing element group, which are arranged in the lens cone, the lens group sequentially includes from an object side to an image side along an optical axis: a first lens with a negative refractive power, a second lens with a refractive power, a third lens with a refractive power, a fourth lens with a refractive power, a fifth lens with a refractive power, and a sixth lens with a negative refractive power. An image-side surface of the first lens is a concave surface. Image-side surfaces of the second lens, the third lens and the fifth lens are all convex surfaces. An object-side surface and an image-side surface of the fourth lens are both convex surfaces or concave surfaces. The spacing element group includes a first spacing element. The optical imaging lens assembly satisfies: −3.45<R1/f<2.75 and 0.75<2×Yc11/d1s<1.25, R1 is a curvature radius of an object-side surface of the first lens, f is an effective focal length of the optical imaging lens assembly, Yc11 is a distance from an inflection point that is farthest from the optical axis in an effective diameter of the object-side surface of the first lens to the optical axis, and d1s is a maximum inner diameter of an object-side surface of the first spacing element in a direction perpendicular to the optical axis.

In some embodiments, the optical imaging lens assembly satisfies: 2.95<EP01/CT1<3.50, EP01 is a distance from an object-side end surface of the lens cone to the object-side surface of the first spacing element along a direction of the optical axis, and CT1 is a center thickness of the first lens on the optical axis.

In some embodiments, the optical imaging lens assembly satisfies: 1.85<(D1s−d1s)/DT12<2.75, D1s is a maximum outer diameter of the object-side surface of the first spacing element in the direction perpendicular to the optical axis, d1s is the maximum inner diameter of the object-side surface of the first spacing element in the direction perpendicular to the optical axis, and DT12 is a maximum effective radius of the image-side surface of the first lens.

In some embodiments, the spacing element group further includes a third spacing element and a fourth spacing element, the third spacing element is arranged on an image side of the third lens and is at least partially in contact with the image-side surface of the third lens, and the fourth spacing element is arranged on an image side of the fourth lens and is at least partially in contact with the image-side surface of the fourth lens; and the optical imaging lens assembly satisfies: 3.45<EP34/|SAG51|+EP34/|SAG52|<14.10, EP34 is a distance from an image-side surface of the third spacing element to an object-side surface of the fourth spacing element along a direction of the optical axis, SAG51 is a distance from an intersection point of an object-side surface of the fifth lens and the optical axis to an effective radius vertex of the object-side surface of the fifth lens on the optical axis, and SAG52 is a distance from an intersection point of the image-side surface of the fifth lens and the optical axis to an effective radius vertex of the image-side surface of the fifth lens on the optical axis.

In some embodiments, the spacing element group further includes a fourth spacing element, the fourth spacing element is arranged on an image side of the fourth lens and is at least partially in contact with the image-side surface of the fourth lens; and the optical imaging lens assembly satisfies: −3.5<(D4s/d4s)/(R7/R8)<−0.6, D4s is a maximum outer diameter of an object-side surface of the fourth spacing element in the direction perpendicular to the optical axis, d4s is a maximum inner diameter of the object-side surface of the fourth spacing element in the direction perpendicular to the optical axis, R7 is a curvature radius of the object-side surface of the fourth lens, and R8 is a curvature radius of the image-side surface of the fourth lens.

In some embodiments, the spacing element group further includes a fifth spacing element, the fifth spacing element is arranged on an image side of the fifth lens and is at least partially in contact with the image-side surface of the fifth lens; and the optical imaging lens assembly satisfies: −1.10<(d0m−d5m)/f5<2.00, d0m is a maximum inner diameter of an image-side end surface of the lens cone in the direction perpendicular to the optical axis, d5m is a maximum inner diameter of an image-side surface of the fifth spacing element in the direction perpendicular to the optical axis, and f5 is an effective focal length of the fifth lens.

In some embodiments, the spacing element group further includes a fourth spacing element and a fifth spacing element, the fourth spacing element is arranged on an image side of the fourth lens and is at least partially in contact with the image-side surface of the fourth lens, and the fifth spacing element is arranged on an image side of the fifth lens and is at least partially in contact with the image-side surface of the fifth lens; and the optical imaging lens assembly satisfies: 0.30≤(d5s−d4s)/|SAG52|≤3.90, d5s is a maximum inner diameter of the object-side surface of the fifth spacing element in the direction perpendicular to the optical axis, d4s is a maximum inner diameter of an object-side surface of the fourth spacing element in the direction perpendicular to the optical axis, and SAG52 is a distance from an intersection point of the image-side surface of the fifth lens and the optical axis to an effective radius vertex of the image-side surface of the fifth lens on the optical axis.

In some embodiments, the spacing element group further includes a third spacing element and a fourth spacing element, the third spacing element is arranged on an image side of the third lens and is at least partially in contact with the image-side surface of the third lens, and the fourth spacing element is arranged on an image side of the fourth lens and is at least partially in contact with the image-side surface of the fourth lens; and the optical imaging lens assembly satisfies: 0.60<CT4/EP34<1.90, CT4 is a center thickness of the fourth lens on the optical axis, and EP34 is a distance from an image-side surface of the third spacing element to an object-side surface of the fourth spacing element along a direction of the optical axis.

In some embodiments, the optical imaging lens assembly satisfies: 10.35<D1s/|SAG12|<18.35, D1s is a maximum outer diameter of the object-side surface of the first spacing element in the direction perpendicular to the optical axis, and SAG12 is a distance from an intersection point of the image-side surface of the first lens and the optical axis to an effective radius vertex of the image-side surface of the first lens on the optical axis.

In some embodiments, the spacing element group further includes a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and the optical imaging lens assembly satisfies: −3.00<R3/d2s+R5/D3s<1.15, R3 is a curvature radius of an object-side surface of the second lens, R5 is a curvature radius of an object-side surface of the third lens, d2s is a maximum inner diameter of an object-side surface of the second spacing element in the direction perpendicular to the optical axis, and D3s is a maximum outer diameter of an object-side surface of the third spacing element in the direction perpendicular to the optical axis.

In some embodiments, the spacing element group further includes a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and the optical imaging lens assembly satisfies: 0.55<|R4/D2m|+|R6/D3m|<1.85, R4 is a curvature radius of the image-side surface of the second lens, R6 is a curvature radius of the image-side surface of the third lens, D2m is a maximum outer diameter of an image-side surface of the second spacing element in the direction perpendicular to the optical axis, and D3m is a maximum outer diameter of the image-side surface of the third spacing element in the direction perpendicular to the optical axis.

In some embodiments, the spacing element group further includes a second spacing element, the second spacing element is arranged on an image side of the second lens and is at least partially in contact with the image-side surface of the second lens; and the optical imaging lens assembly satisfies: 2.40<EP02/T12<2.75, EP02 is a distance from an object-side end surface of the lens cone to an object-side surface of the second spacing element along a direction of the optical axis, and T12 is an air gap between the first lens and the second lens on the optical axis.

In some embodiments, the spacing element group further includes a second spacing element, the second spacing element is arranged on an image side of the second lens and is at least partially in contact with the image-side surface of the second lens; and the optical imaging lens assembly satisfies: 1.35<|f12|/d2s<7.60, f12 is a combined focal length of the first lens and the second lens, and d2s is a maximum inner diameter of the object-side surface of the second spacing element in the direction perpendicular to the optical axis.

In some embodiments, the optical imaging lens assembly further includes an automatic focusing element arranged between the third lens and the fourth lens.

Some other embodiments of the disclosure provide such an optical imaging lens assembly. The optical imaging lens assembly includes: a lens cone, and a lens group and a spacing element group, which are arranged in the lens cone, the lens group sequentially includes from an object side to an image side along an optical axis: a first lens with a negative refractive power, a second lens with a refractive power, a third lens with a refractive power, a fourth lens with a refractive power, a fifth lens with a refractive power, and a sixth lens with a negative refractive power. Image-side surfaces of the second lens, the third lens and the fifth lens are all convex surfaces. An object-side surface and an image-side surface of the fourth lens are both convex surfaces or concave surfaces. The spacing element group includes a first spacing element. The optical imaging lens assembly satisfies: −3.45<R1/f<2.75 and 1.85<(D1s−d1s)/DT12<2.75, R1 is a curvature radius of an object-side surface of the first lens, R2 is a curvature radius of an image-side surface of the first lens, D1s is a maximum outer diameter of an object-side surface of the first spacing element in a direction perpendicular to the optical axis, d1s is a maximum inner diameter of the object-side surface of the first spacing element in the direction perpendicular to the optical axis, and DT12 is a maximum effective radius of the image-side surface of the first lens.

The disclosure provides a six-piece optical imaging lens assembly, the first lens thereof has the negative refractive power, the sixth lens thereof has the negative refractive power, and the optical imaging lens assembly satisfies: −3.45<R1/f<2.75. Therefore, by means of controlling the curvature radius of the object-side surface of the first lens within a certain range, an off-axis aberration of the system is able to be effectively corrected while ensuring good wide-angle characteristics of the lens. However, under the condition of ensuring the wide-angle characteristics, the off-axis light performance is also affected by the position of the inflection point, since the first lens has the negative refractive power, the effective radius of the object-side surface thereof is often designed to be relatively large, so the position of the inflection point has a greater impact on MTF performance. In the disclosure, by means of designing the first spacing element on the image-side surface of the first lens, and making the optical imaging lens assembly satisfy 0.75<2×Yc11/d1s<1.25, the inner diameter of the object-side surface of the first spacing element is controlled, and non-imaging light is able to be intercepted as much as possible; and meanwhile, by means of controlling the position of the inflection point of the object-side surface of the first lens, the impact of the position of the inflection point of the object-side surface of the first lens on the off-axis light is able to be reduced, the MTF performance of the lens is ensured, and the imaging stability is improved.

### BRIEF DESCRIPTION OF THE DRAWINGS

Other features, objectives and advantages of the disclosure will become more apparent upon reading the detailed description of non-limiting embodiments with reference to the following drawings.

FIG. 1 shows a structure arrangement diagram of an optical imaging lens assembly and a schematic diagram of some parameters according to the disclosure.

FIG. 2 shows a structural schematic diagram of an optical imaging lens assembly according to Embodiment 1 of the disclosure.

FIG. 3 shows a structural schematic diagram of an optical imaging lens assembly according to Embodiment 2 of the disclosure.

FIG. 4 shows a structural schematic diagram of an optical imaging lens assembly according to Embodiment 3 of the disclosure.

FIG. 5 shows a longitudinal aberration curve (A1), an astigmatism curve (B1), a distortion curve (C1) and a lateral color curve (D1) of an optical imaging lens assembly according to Embodiment 1 to Embodiment 3 of the disclosure.

FIG. 6 shows a structural schematic diagram of an optical imaging lens assembly according to Embodiment 4 of the disclosure.

FIG. 7 shows a structural schematic diagram of an optical imaging lens assembly according to Embodiment 5 of the disclosure.

FIG. 8 shows a structural schematic diagram of an optical imaging lens assembly according to Embodiment 6 of the disclosure.

FIG. 9 shows a longitudinal aberration curve (A2), an astigmatism curve (B2), a distortion curve (C2) and a lateral color curve (D2) of an optical imaging lens assembly according to Embodiment 4 to Embodiment 6 of the disclosure.

FIG. 10 shows a structural schematic diagram of an optical imaging lens assembly according to Embodiment 7 of the disclosure.

FIG. 11 shows a structural schematic diagram of an optical imaging lens assembly according to Embodiment 8 of the disclosure.

FIG. 12 shows a structural schematic diagram of an optical imaging lens assembly according to Embodiment 9 of the disclosure.

FIG. 13 shows a longitudinal aberration curve (A3), an astigmatism curve (B3), a distortion curve (C3) and a lateral color curve (D3) of an optical imaging lens assembly according to Embodiment 7 to Embodiment 9 of the disclosure.

FIG. 14 shows a defocus curve diagram with an optical imaging lens assembly satisfying: 2×Yc11/d1s=1.06.

FIG. 15 shows a defocus curve diagram with an optical imaging lens assembly satisfying: 2×Yc11/d1s=0.5.

FIG. 16 shows a defocus curve diagram with an optical imaging lens assembly satisfying: 2×Yc11/d1s=2.75.

### DETAILED DESCRIPTION OF THE EMBODIMENTS

For a better understanding of the disclosure, various aspects of the disclosure will be described in more detail with reference to the drawings. It should be understood that these detailed descriptions are merely descriptions of specific embodiments of the disclosure, and are not intended to limit the scope of the disclosure in any way. Throughout the specification, the same reference signs refer to the same elements. The expression “and/or” includes any and all combinations of one or more of associated listed items.

It should be noted that in the specification, expressions such as first, second and third are only used to distinguish one feature from another feature, but do not indicate any limitation to the features. Therefore, without departing from the teachings of the disclosure, a first lens discussed below may also be referred to as a second lens or a third lens.

In the drawings, for ease of description, the thickness, size and shape of the lens have been slightly exaggerated. Specifically, the shape of a spherical surface or an aspheric surface shown in the drawings is shown by way of example. That is, the shape of the spherical surface or the aspheric surface is not limited to the shape of the spherical surface or the aspheric surface shown in the drawings. The drawings are merely examples and are not strictly drawn to scale.

It should be understood by those skilled in the art that, a lens is an optical element formed by two refracting surfaces surrounding a transparent medium. The refracting surface may be a spherical surface (including a plane, that is, a spherical surface with an infinite curvature radius) and an aspheric surface. A connecting line of curvature centers of the two refracting surfaces is an optical axis of the lens. Herein, a surface of the two refracting surfaces close to a photographed object is referred to as an object-side surface of the lens, and a surface close to an imaging surface is referred to as an image-side surface of the lens.

Herein, a paraxial region refers to a region in the vicinity of the optical axis. If the surface of the lens is a convex surface and the position of the convex surface is not defined, it indicates that the surface of the lens is a convex surface at least in the paraxial region; and if the surface of the lens is a concave surface and the position of the concave surface is not defined, it indicates that the surface of the lens is a concave surface at least in the paraxial region. The surface shape in the paraxial region may be judged according to a general method in the art, for example, the concave-convex shape is judged by positive and negative properties of an R value (R refers to a curvature radius of the paraxial region). For the object-side surface, when the R value is positive, it is judged that the object-side surface is a convex surface, and when the R value is negative, it is judged that the object-side surface is a concave surface; and for the image-side surface, when the R value is positive, it is judged that the image-side surface is a concave surface, and when the R value is negative, it is judged that the image-side surface is a convex surface.

The solutions in the embodiments of the disclosure are able to be simulated by using software/tools such as ZEMAX and CODE V, and the solutions in some embodiments are simulated by using CODE V as an example. During simulation by using such software/tools, the surface shape of the surface of the lens may be appropriately adjusted according to an own surface shape model of the software/tool used.

It should also be understood that, the terms “include”, “including”, “have”, “contain” and/or “containing”, when used in the present specification, indicate the presence of stated features, elements and/or components, but do not preclude the presence or addition of one or more other features, elements, components and/or combinations thereof. In addition, when an expression such as “at least one of . . . ” occurs after a list of listed features, the expression modifies the entire list of features, rather than modifying individual elements in the list. In addition, when the embodiments of the disclosure are described, “may” is used to indicate “one or more implementations of the disclosure”. Moreover, the term “exemplary” is intended to refer to an example or illustration.

Unless otherwise defined, all terms (including technical terms and scientific terms) used herein have the same meanings as commonly understood by those ordinary skilled in the art to which the disclosure belongs. It should also be understood that terms (e.g., terms defined in commonly used dictionaries) should be interpreted as with meanings consistent with those in the context of related art and will not be interpreted in an idealized or overly formal sense, unless expressly so defined herein.

It should be noted that, in the case of no conflict, embodiments in the disclosure and features in the embodiments may be combined with each other. The following embodiments only express several implementations of the disclosure, and the description thereof is relatively specific and detailed, but cannot be understood as limitations to the protection scope of the disclosure. It should be pointed out that, for those ordinary skilled in the art, several modifications and improvements may also be made without departing from the concept of the disclosure, and all these modifications and improvements fall within the protection scope of the disclosure, for example, a lens group, a lens cone and a spacing element in various embodiments of the disclosure may be arbitrarily combined, and it is not limited to that the lens group in one embodiment may only be combined with the lens cone, the spacing element and the like in the embodiment.

The disclosure will be described in detail below with reference to the drawings and in combination with the embodiments.

For a six-piece wide-angle lens, several important indicators, that is, a large viewing angle, a large image surface and ultra-thinness, are mutually restricted, for example, if the two indicators of large viewing angle and ultra-thinness are superimposed, stray light and an MTF performance risk are increased. Generally, a first lens of the six-piece wide-angle lens has a negative refractive power, which helps to achieve a design of a wide-angle optical system. By means of controlling, for example, a curvature radius of an object-side surface of the first lens within a certain range, a positive effect is played to correct an off-axis aberration of the system, however, the off-axis light performance is also impacted by an effective radius and a position of a deflection point under a condition of ensuring wide-angle characteristics. Specifically, since the first lens has the negative refractive power, an effective diameter of the object-side surface thereof is often designed to be relatively large, so that the effective diameter and the position of the inflection point have a greater impact on the MTF performance, when the inflection point is too close to an optical axis, a curvature offset of an external field of view becomes severe, and when the inflection point is too close to a maximum effective radius of the first lens, a performance drop of the external field of view tends to be server, resulting in blurring of an edge image.

Some embodiments of the disclosure provide such an optical imaging lens assembly. The optical imaging lens assembly includes a lens group, a spacing element group and a lens cone, wherein the lens group and the spacing element group are arranged in the lens cone. The lens group includes a first lens, a second lens, a third lens, a fourth lens, a fifth lens and a six lens, which are sequentially arranged from an object side to an image side along an optical axis. The first lens has a negative refractive power, and an image-side surface thereof is a convex surface; the third lens has a positive refractive power, and an object-side surface thereof is a convex surface; an object-side surface of the fourth lens is a convex surface; an object-side surface of the fifth lens is a concave surface; and an image-side surface of the sixth lens is a concave surface. The optical imaging lens assembly satisfies: −3.45<R1/f<2.75. According to the optical imaging lens assembly of the disclosure, by means of controlling a curvature radius of an object-side surface of the first lens within a certain range, the off-axis aberration of the system is effectively corrected, and meanwhile, it is ensured that the lens achieves good wide-angle characteristics.

In some embodiments, the spacing element group includes a first spacing element, and the first spacing element is arranged on an image side of the first lens and is at least partially in contact with the image-side surface of the first lens. The optical imaging lens assembly satisfies: 0.75<2×Yc11/d1s<1.25, wherein Yc11 is a distance from an inflection point that is farthest from the optical axis in an effective diameter of the object-side surface of the first lens to the optical axis, and d1s is a maximum inner diameter of an object-side surface of the first spacing element in a direction perpendicular to the optical axis. By means of controlling the inner diameter of the object-side surface of the first spacing element, non-imaging light is able to be intercepted as much as possible; and meanwhile, by means of controlling the position of the inflection point of the object-side surface of the first lens, an impact of the position of the inflection point of the object-side surface of the first lens on the off-axis light is able to be reduced, the MTF performance of the lens is ensured, and the imaging stability is improved.

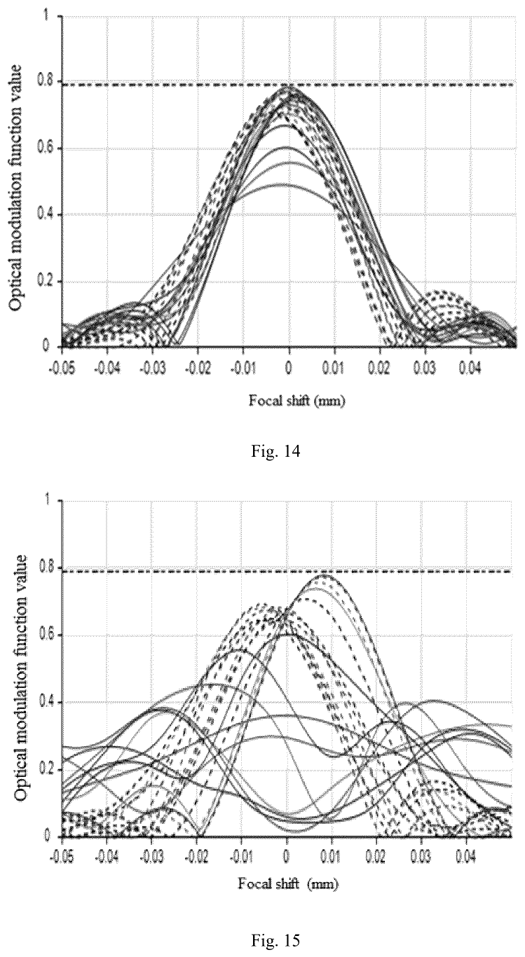

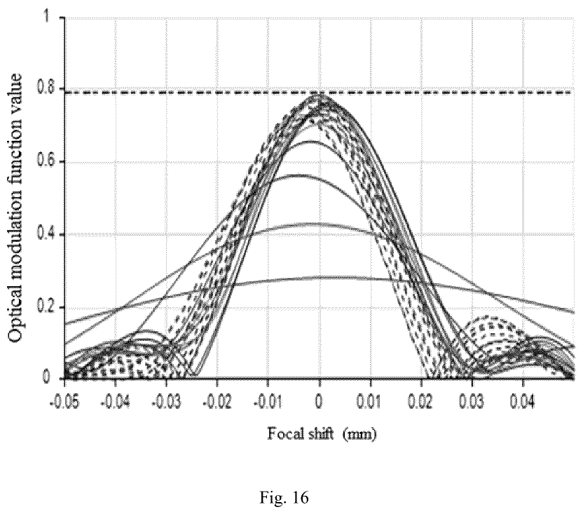

With reference to FIGS. 14-16, it is further illustrated that the optical imaging lens assembly of the disclosure has good imaging stability when satisfying−3.45<R1/f<2.75 and 0.75<2×Yc11/d1s<1.25, and a stability of an MTF peak value is able to be ensured. Specifically, FIG. 14 shows a defocus curve diagram with a first optical imaging lens assembly satisfying: 2×Yc11/d1s=1.06, FIG. 15 shows a defocus curve diagram with a second optical imaging lens assembly satisfying: 2×Yc11/d1s=0.5, and FIG. 16 shows a defocus curve diagram with a third optical imaging lens assembly satisfying: 2×Yc11/d1s=2.75.

As it can be seen from comparison of FIGS. 14-16 that, the first optical imaging lens assembly satisfies the range of 0.75<2×Yc11/d1s<1.25 of the disclosure, that is, the distance from the inflection point of the effective diameter of the first lens to the optical axis and the inner diameter of the object-side surface of the first spacing element are controlled within the reasonable range, so that the non-imaging light is able to be intercepted, it is ensured that positions of peak values of defocus curves are relatively concentrated, focal points better converge, and good imaging quality of each field of view is able to be obtained. The second optical imaging lens assembly and the third optical imaging lens assembly do not satisfy the range of 0.75<2×Yc11/d1s<1.25 of the disclosure, the positions of the peak values of the defocus curves are relatively dispersed, and the focal points offset relatively seriously. Specifically, a position of the inflection point of the second optical imaging lens assembly is too close to the optical axis, such that a light of the field of view beyond 0.2 F is not able to converge, which is manifested as that the curvature offset of an external field of view is serious, and the degradation of the MTF performance is severe. A position of the inflection point of the third optical imaging lens assembly is too close to the inner diameter of the object-side surface of the first spacing element, such that the light of the external field of view is intercepted more, the image quality of the field of view beyond 0.8 F is blurred, and the MTF performance becomes worse.

In an embodiment, the spacing element group includes a first spacing element, and the first spacing element is arranged on an image side of the first lens and is at least partially in contact with the image-side surface of the first lens. The optical imaging lens assembly satisfies: 1.85<(D1s−d1s)/DT12<2.75, wherein D1s is a maximum outer diameter of the object-side surface of the first spacing element in the direction perpendicular to the optical axis, d1s is the maximum inner diameter of the object-side surface of the first spacing element in the direction perpendicular to the optical axis, and DT12 is a maximum effective radius of the image-side surface of the first lens. Since 1.85<(D1s−d1s)/DT12<2.75 is satisfied, by means of controlling the inner and outer diameters of the object-side surface of the first spacing element and the maximum effective radius of the image-side surface of the first lens, a supporting area of the first lens and the first spacing element is able to be reasonably controlled to prevent the problem of worse assembly stability due to an excessively large segment gap between the lens and a support member during an assembly process.

In an embodiment, the optical imaging lens assembly further includes a diaphragm. The diaphragm is arranged between the third lens and the fourth lens. It should be noted that a position of the diaphragm disclosed herein is merely an example and not a limitation; and in another embodiment, the diaphragm is also able to be arranged at other positions according to actual needs.

In an embodiment, the spacing element group includes one or more of the first spacing element, a second spacing element, a third spacing element, a fourth spacing element, a fifth spacing element and a sixth spacing element, wherein the first spacing element is arranged on the image side of the first lens and is at least partially in contact with the image-side surface of the first lens. The second spacing element is arranged on an image side of the second lens and is at least partially in contact with an image-side surface of the second lens. The third spacing element is arranged on an image side of the third lens and is at least partially in contact with an image-side surface of the third lens. The fourth spacing element is arranged on an image side of the fourth lens and is at least partially in contact with an image-side surface of the fourth lens. The fifth spacing element is arranged on an image side of the fifth lens and is at least partially in contact with an image-side surface of the fifth lens. The sixth spacing element is arranged on an image side of the sixth lens and is at least partially in contact with the image-side surface of the sixth lens. It should be understood that the disclosure does not specifically limit the number of spacing elements, any number of spacing elements is able to be included between any two lenses, and the entire optical imaging lens assembly is also able to include any number of spacing elements. By reasonably using the spacing elements, a risk of stray light is able to be effectively avoided, and an interference to the image quality is reduced, thereby improving the imaging quality of the optical imaging lens assembly.

In an embodiment, the lens cone includes an object-side end surface, an image-side end surface, an outer ring surface and an inner ring surface, wherein an end surface of the lens cone closest to the object side is the object-side end surface of the lens cone, and an end surface of the lens cone closest to the image side is the image-side end surface of the lens cone; and in the direction perpendicular to the optical axis, a surface of the lens cone farthest from the optical axis is the outer ring surface, and a surface of the lens cone closest to the optical axis is the inner ring surface.

In an embodiment, the lens cone is an integrated lens cone or a split lens cone.

In an embodiment, the optical imaging lens assembly further includes an automatic focusing element, and the automatic focusing element is arranged between the third lens and the fourth lens. The automatic focusing element has advantages of low power consumption, fast focusing and miniaturization, and is also able to eliminate temperature excursion to ensure the performance of the lens. It should be noted that a position of the automatic focusing element disclosed herein is merely an example and not a limitation; and in another embodiment, the automatic focusing element is also able to be arranged at other positions according to actual needs.

In an embodiment, the first lens has a negative refractive power, the second lens has a positive refractive power or a negative refractive power, the third lens has a positive refractive power or a negative refractive power, the fourth lens has a positive refractive power or a negative refractive power, the fifth lens has a positive refractive power or a negative refractive power, and the sixth lens has a negative refractive power.

In an embodiment, the image-side surface of the first lens is a concave surface.

In an embodiment, image-side surfaces of the second lens, the third lens and the fifth lens are all convex surfaces.

In an embodiment, the object-side surface and the image-side surface of the fourth lens are both convex surfaces or concave surfaces.

In an embodiment, there is at least one edge-cut lens in the lens group. A peripheral surface of the edge-cut lens is provided with an edge-cut portion and a non-edge-cut portion, and an outer diameter of the edge-cut portion of the lens is less than an outer diameter of the non-edge-cut portion of the lens. When the peripheral surface of the lens is provided with the edge-cut portion, the outer diameter of the lens generally refers to the outer diameter of the non-edge-cut portion of the lens.

In an embodiment, there is at least one edge-cut spacing element in the spacing element group. A peripheral surface of the edge-cut spacing element is provided with an edge-cut portion and a non-edge-cut portion, and an outer diameter of the edge-cut portion of the spacing element is less than an outer diameter of the non-edge-cut portion of the spacing element. The outer diameter of the spacing element generally refers to a maximum outer diameter of the non-edge-cut portion.

In an embodiment, the optical imaging lens assembly according to the disclosure satisfies: 2.95<EP01/CT1<3.50, wherein EP01 is a distance from the object-side end surface of the lens cone to the object-side surface of the first spacing element along a direction of the optical axis, and CT1 is a center thickness of the first lens on the optical axis. Since 2.95<EP01/CT1<3.50 is satisfied, a thickness ratio of the first lens is able to be effectively controlled within a reasonable range, so that a stability of the center thickness and an edge thickness of the first lens is ensured under external conditions such as high humidity, high temperature and drop of the lens, so as to ensure that the imaging effect of the lens is less affected by external interference.

In an embodiment, the optical imaging lens assembly according to the disclosure satisfies: 3.45<EP34/|SAG51|+EP34/|SAG52|<14.10, wherein EP34 is a distance from an image-side surface of the third spacing element to an object-side surface of the fourth spacing element along the direction of the optical axis, SAG51 is a distance from an intersection point of the object-side surface of the fifth lens and the optical axis to an effective radius vertex of the object-side surface of the fifth lens on the optical axis, and SAG52 is a distance from an intersection point of the image-side surface of the fifth lens and the optical axis to an effective radius vertex of the image-side surface of the fifth lens on the optical axis. Since 3.45<EP34/|SAG51|+EP34/|SAG52|<14.10 is satisfied, by means of reasonably setting a vector height of the fifth lens, a lateral chromatic aberration, spherochromatic aberration, astigmatism, field curvature and the like of the system are able to be effectively improved, and an overall imaging quality of an off-axis field of view is improved; and meanwhile, by means of controlling EP34, it is conducive to controlling radial segment gaps of the third spacing element and the fourth spacing element with the lens cone, thereby facilitating an arrangement design of a lens flange mechanism, and minimizing the assembly difficulty and risk.

In an embodiment, the optical imaging lens assembly according to the disclosure satisfies: −3.5< (D4s/d4s)/(R7/R8)<−0.6, wherein D4s is a maximum outer diameter of the object-side surface of the fourth spacing element in the direction perpendicular to the optical axis, d4s is a maximum inner diameter of the object-side surface of the fourth spacing element in the direction perpendicular to the optical axis, R7 is a curvature radius of the object-side surface of the fourth lens, and R8 is a curvature radius of the image-side surface of the fourth lens. Since −3.5<(D4s/d4s)/(R7/R8)<−0.6 is satisfied, the curvature radius of the object-side surface and the curvature radius of the image-side surface of the fourth lens are able to be effectively controlled within a reasonable range, and meanwhile, the inner diameter of the object-side surface of the fourth spacing element is cooperatively controlled, so that it can be ensured that a light of an edge field of view has a reasonable angle of field of view, the off-axis aberration is able to be corrected, and the imaging quality of the system is able to be improved.

In an embodiment, the optical imaging lens assembly according to the disclosure satisfies: −1.10<(d0m−d5m)/f5<2.00, wherein d0m is a maximum inner diameter of the image-side end surface of the lens cone in the direction perpendicular to the optical axis, d5m is a maximum inner diameter of an image-side surface of the fifth spacing element in the direction perpendicular to the optical axis, and f5 is an effective focal length of the fifth lens. Since −1.10<(d0m−d5m)/f5<2.00 is satisfied, the inner diameter of the image-side surface of the fifth spacing element is able to be effectively controlled, it is ensured that a volume and weight of the spacing element are controlled while unnecessary light is effectively intercepted, a machining difficulty and forming difficulty of a mold are reduced, and the imaging quality is ensured; and the effective focal length of the fifth lens and the inner diameter of the image-side end surface of the lens cone are constrained, thereby helping the fifth lens to receive and transit the light of front and rear lenses thereof, so as to adjust a trend of the light, so that the imaging quality is higher, and an imaging distortion is weakened.

In an embodiment, the optical imaging lens assembly according to the disclosure satisfies: 0.30≤(d5s−d4s)/|SAG52|≤3.90, wherein d5s is a maximum inner diameter of the object-side surface of the fifth spacing element in the direction perpendicular to the optical axis, d4s is the maximum inner diameter of the object-side surface of the fourth spacing element in the direction perpendicular to the optical axis, and SAG52 is the distance from the intersection point of the image-side surface of the fifth lens and the optical axis to the effective radius vertex of the image-side surface of the fifth lens on the optical axis. Since 0.30≤(d5s−d4s)/|SAG52|<3.90 is satisfied, by means of reasonably designing the vector height of the image-side surface of the fifth lens, an uniformity of a structure of the fifth lens is able to be effectively controlled, the lateral chromatic aberration, spherochromatic aberration, astigmatism, field curvature and the like of the system are able to be effectively improved, the overall imaging quality of the off-axis field of view is improved, and a forming and machining of the lens are facilitated; and meanwhile, by means of controlling the inner diameters of the object-side surfaces of the fourth spacing element and the fifth spacing element, stray light at an edge of the fourth lens is able to be effectively intercepted to ensure that an imaging apparatus has higher imaging quality.

In an embodiment, the optical imaging lens assembly according to the disclosure satisfies: 0.60<CT4/EP34<1.90, wherein CT4 is a center thickness of the fourth lens on the optical axis, and EP34 is the distance from the image-side surface of the third spacing element to the object-side surface of the fourth spacing element along the direction of the optical axis. Since 0.60<CT4/EP34<1.90 is satisfied, a thickness ratio of the fourth lens is able to be effectively controlled within a reasonable range, thereby ensuring a forming stability of the fourth lens and effectively avoiding an assembly deformation of the fourth lens during the assembly process.

In an embodiment, the optical imaging lens assembly according to the disclosure satisfies: 10.35<D1s/|SAG12|<18.35, wherein D1s is a maximum outer diameter of the object-side surface of the first spacing element in the direction perpendicular to the optical axis, and SAG12 is a distance from an intersection point of the image-side surface of the first lens and the optical axis to an effective radius vertex of the image-side surface of the first lens on the optical axis. Since 10.35<D1s/|SAG12|<18.35 is satisfied, by means of reasonably designing the loss of height of the image-side surface of the first lens, the lateral chromatic aberration, spherochromatic aberration, astigmatism, field curvature and the like of the system are able to be effectively improved, the overall imaging quality of the off-axis field of view is improved, an uniformity of a structure of the first lens is able to be effectively controlled, and the forming and machining of the lens are facilitated; and meanwhile, by means of controlling the outer diameter of the object-side surface of the first spacing element, stray light at the edge of the first lens is able to be effectively intercepted to ensure that the imaging apparatus has higher imaging quality.

In an embodiment, the optical imaging lens assembly according to the disclosure satisfies: −3.00<R3/d2s+R5/D3s<1.15, wherein R3 is a curvature radius of an object-side surface of the second lens, R5 is the curvature radius of the object-side surface of the third lens, d2s is a maximum inner diameter of an object-side surface of the second spacing element in the direction perpendicular to the optical axis, and D3s is a maximum outer diameter of an object-side surface of the third spacing element in the direction perpendicular to the optical axis. Since −3.00<R3/d2s+R5/D3s<1.15 is satisfied, by means of controlling the inner diameter of the object-side surface of the second spacing element and the outer diameter of the object-side surface of the third spacing element, it is conducive to ensuring a reception of light at the second lens and the third lens, so that the imaging quality is higher, and meanwhile unnecessary light is able to be effectively intercepted.

In an embodiment, the optical imaging lens assembly according to the disclosure satisfies: 0.55<|R4/D2m|+|R6/D3m|<1.85, wherein R4 is a curvature radius of the image-side surface of the second lens, R6 is a curvature radius of the image-side surface of the third lens, D2m is a maximum outer diameter of the image-side surface of the second spacing element in the direction perpendicular to the optical axis, and D3m is a maximum outer diameter of the image-side surface of the third spacing element in the direction perpendicular to the optical axis. Since 0.55<|R4/D2m|+|R6/D3m|<1.85 is satisfied, shapes of image-side surfaces of the second lens and the third lens are able to be reasonably controlled, thereby facilitating lens machining and ensuring a stability of a lens forming process; and meanwhile, by means of controlling the outer diameters of the image-side surfaces of the second spacing element and the third spacing element, non-imaging light is able to be effectively intercepted, and the imaging quality of the imaging apparatus is improved.

In an embodiment, the optical imaging lens assembly according to the disclosure satisfies: 2.40<EP02/T12<2.75, wherein EP02 is a distance from the object-side end surface of the lens cone to the object-side surface of the second spacing element along the direction of the optical axis, and T12 is an air gap between the first lens and the second lens on the optical axis. Since 2.40<EP02/T12<2.75 is satisfied, by means of controlling a spacing distance between the object-side end surface of the lens cone and the object-side surface of the second spacing element and the distance between the first lens and the second lens, a radial segment gap between the second spacing element and the lens cone is able to be reasonably controlled to prevent a problem of worse assembly stability due to an excessively large segment gap between the lens and a support member during the assembly process.

In an embodiment, the optical imaging lens assembly according to the disclosure satisfies: 1.35<|f12|/d2s<7.60, wherein f12 is a combined focal length of the first lens and the second lens, and d2s is the maximum inner diameter of the object-side surface of the second spacing element in the direction perpendicular to the optical axis. Since 1.35<|f12|/d2s<7.60 is satisfied, by means of controlling the combined focal length of the first lens and the second lens, it is ensured that an imaging system is better imaged to an image surface, thereby improving an imaging quality of the lens; and by means of controlling the inner diameter of the object-side surface of the second spacing element, it is conducive to ensuring the arrangement stability of the structure of the lens, ensuring a connection of front and rear imaging systems, and improving the assembly stability.

In the embodiments of the disclosure, at least one of lens surfaces of each lens is an aspheric lens surface, that is, at least one lens surface among the object-side surface of the first lens to the image-side surface of the sixth lens is an aspheric lens surface. An aspheric lens is characterized in that the curvature continuously changes from the center of the lens to the periphery of the lens. Unlike a spherical lens with a constant curvature from the center of the lens to the periphery of the lens, the aspheric lens has a better curvature radius characteristic, and thus has the advantages of improving the distortion aberration and improving the astigmatic aberration. After the aspheric lens is used, aberrations appearing during imaging may be eliminated as much as possible, thereby improving the imaging quality. In an embodiment, the object-side surfaces and the image-side surfaces of all lenses among the first lens to the sixth lens are aspheric lens surfaces.

In an embodiment, the optical imaging lens assembly further includes an optical filter used for correcting chromatic aberration and/or protective glass used for protecting a photosensitive element located on an imaging surface.

It should be understood that the disclosure focuses on a performance optimization of the six-piece wide-angle lens, specifically, the disclosure focuses on how to overcome the problem that, for example, the effective radius and the position of the inflection point have a greater impact on the MTF performance due to the fact that the first lens has the negative refractive power and thus the effective radius of the object-side surface thereof is often designed to be relatively large, or the problem that the assembly stability is worse due to the excessively large segment gap between the lens and the support member. A specific refractive power distribution of the six lenses and a surface type setting of each lens are not mainly focused on in the disclosure, and these settings are able to be correspondingly adjusted according to needs. That is to say, although several specific refractive power distribution and surface type settings are shown for an imaging lens group in the embodiments of the disclosure, it should be understood that the imaging lens group in the disclosure should not be limited to the several specific situations shown in the embodiments.

The optical imaging lens assembly according to the above embodiments of the disclosure is able to adopt a plurality of lenses, for example, six lenses as described above. However, those skilled in the art should understand that, without departing from the technical solutions claimed in the disclosure, the number of lenses constituting the optical imaging lens assembly is able to be changed to obtain various results and advantages described in the specification. For example, although the six lenses are taken as an example for description in the embodiments, the optical imaging lens assembly is not limited to including six lenses. The optical imaging lens assembly is also able to include other numbers of lenses as needed.

Specific embodiments of the optical imaging lens assembly applicable to the above embodiments are further described below with reference to the drawings.

### Embodiment 1

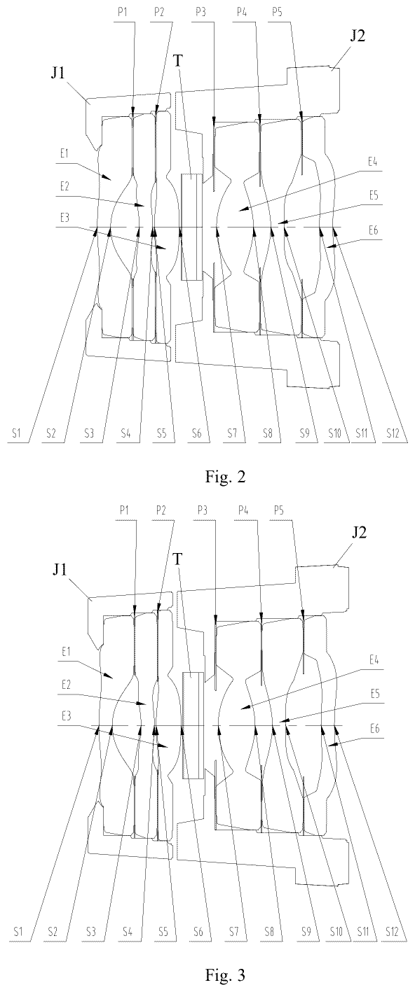

FIG. 2 shows a structural schematic diagram of an optical imaging lens assembly according to Embodiment 1 of the disclosure. As shown in FIG. 2, the optical imaging lens assembly includes a lens cone, a lens group and a spacing element group. The lens cone is a split lens cone, which includes a first lens cone J1 and a second lens cone J2. The lens group of the optical imaging lens assembly sequentially includes from an object side to an image side: a first lens E1, a second lens E2, a third lens E3, a fourth lens E4, a fifth lens E5 and a sixth lens E6. The first lens E1 has an object-side surface S1 and an image-side surface S2. The second lens E2 has an object-side surface S3 and an image-side surface S4. The third lens E3 has an object-side surface S5 and an image-side surface S6. The fourth lens E4 has an object-side surface S7 and an image-side surface S8. The fifth lens E5 has an object-side surface S9 and an image-side surface S10. The sixth lens E6 has an object-side surface S11 and an image-side surface S12.

The optical imaging lens assembly further includes an automatic focusing element T arranged between the third lens E3 and the fourth lens E4. The optical imaging lens assembly further includes a diaphragm STO (not shown) arranged between the third lens E3 and the fourth lens E4, and more specifically, the diaphragm STO is arranged between the automatic focusing element T and the fourth lens E4.

Light from an object sequentially passes through the surfaces S1 to S12 and is finally imaged on an imaging surface (not shown).

Table 1 shows a basic parameter table of the lens group of the optical imaging lens assembly in Embodiment 1, wherein a curvature radius, a thickness/distance and an effective focal length are all in units of millimeters (mm).

TABLE 1

| | | | | Material | | Effective | |
|---|---|---|---|---|---|---|---|
| Surface | Surface | Curvature | Thickness/ | Refractive | Abbe | focal | Conic |
| number | type | radius | distance | index | number | length | coefficient |
| OBJ | Spherical | Infinite | Infinite | | | | |
| S1 | Aspheric | 4.9851 | 0.2513 | 1.54 | 55.71 | −2.54 | 2.5772 |
| S2 | Aspheric | 1.0523 | 0.5414 | | | | −0.0915 |
| S3 | Aspheric | −1.5084 | 0.2500 | 1.68 | 19.24 | −21.79 | −3.4653 |
| S4 | Aspheric | −1.7926 | 0.0328 | | | | −0.9028 |
| S5 | Aspheric | 4.0836 | 0.4681 | 1.55 | 56.09 | 4.36 | 4.4207 |
| S6 | Aspheric | −5.4634 | 0.0300 | | | | −2.7278 |
| T | Spherical | Variable | 0.6300 | | | | |
| STO | Spherical | Infinite | 0.0395 | | | | |
| S7 | Aspheric | 1.3937 | 0.6936 | 1.55 | 56.09 | 1.40 | −1.6947 |
| S8 | Aspheric | −1.3961 | 0.3274 | | | | 1.0197 |
| S9 | Aspheric | −1.3518 | 0.2500 | 1.68 | 19.24 | −2.23 | 0.6866 |
| S10 | Aspheric | −13.6838 | 0.6664 | | | | −46.0512 |
| S11 | Aspheric | 6.2580 | 0.2500 | 1.54 | 55.71 | −334.51 | −99.0000 |
| S12 | Aspheric | 5.9628 | 0.0937 | | | | −11.6307 |

In Embodiment 1, object-side surfaces and image-side surfaces of the first lens E1 to the sixth lens E6 are all aspheric surfaces, and surface types of the aspheric lenses may be defined by using, but not limited to, the following aspheric formula:

$$χ = \frac{c {h}^{2}}{1 + \sqrt{1 - ( k + 1 ) {c}^{2} {h}^{2}}} + Σ A i {h}^{i} \qquad ( 1 )$$

wherein x is a vector height of a distance between the aspheric surface and a vertex of the aspheric surface when the height of the aspheric surface is located at a position with the height h in the optical axis direction; c is a paraxial curvature of the aspheric surface, c=1/R (that is, the paraxial curvature c is a reciprocal of the curvature radius R in Table 1); k is a conic coefficient; and Ai is a correction coefficient of an i-th order of the aspheric surface. Table 2 shows high-order term 10 coefficients A4, A6, A8, A10, A12, A14, A16, A18 and A20 that may be used for the aspheric lens surfaces S1-S12 in Embodiment 1.

TABLE 2

| Surface | | | | | | | | | |
|---|---|---|---|---|---|---|---|---|---|
| number | A4 | A6 | A8 | A10 | A12 | A14 | A16 | A18 | A20 |
| S1 | 1.2786E−01 | −5.7930E−01 | 6.6223E−01 | −4.0994E−01 | 1.5916E−01 | −3.6824E−02 | 3.8515E−03 | 0.0000E+00 | 0.0000E+00 |
| S2 | 3.0064E−01 | −9.8207E−01 | 1.3588E+00 | −4.5231E+00 | 1.4296E+01 | −2.3581E+01 | 1.8074E+01 | −5.2080E+00 | 0.0000E+00 |
| S3 | 5.0308E−01 | −2.4027E−01 | −2.5163E+00 | 2.0131E+01 | −6.9182E+01 | 1.3245E+02 | −1.4628E+02 | 8.3563E+01 | −1.8079E+01 |
| S4 | 1.0530E+00 | −4.5513E+00 | 1.9383E+01 | −5.0475E+01 | 8.1712E+01 | −7.5318E+01 | 2.9594E+01 | 4.0111E−02 | 0.0000E+00 |
| S5 | 6.3683E−01 | −5.6737E+00 | 2.5531E+01 | −7.5473E+01 | 1.4225E+02 | −1.7005E+02 | 1.2850E+02 | −5.9965E+01 | 1.4757E+01 |
| S6 | −1.2649E−01 | −2.0889E−01 | 3.0267E−01 | −1.0211E+00 | 8.8120E−01 | 4.7002E+00 | −1.3926E+01 | 1.4705E+01 | −5.6844E+00 |
| S7 | 7.7159E−02 | 9.6174E−03 | −4.4363E−01 | 1.8217E+00 | −3.4060E+00 | 2.9884E+00 | −7.6075E−01 | 0.0000E+00 | 0.0000E+00 |
| S8 | 2.8616E−01 | −4.6915E−01 | 2.4219E+00 | −8.4596E+00 | 1.8339E+01 | −2.1251E+01 | 1.0479E+01 | 0.0000E+00 | 0.0000E+00 |
| S9 | 6.5513E−01 | −1.6282E+00 | 5.7921E+00 | −1.6815E+01 | 2.9957E+01 | −2.8596E+01 | 1.1742E+01 | 0.0000E+00 | 0.0000E+00 |
| S10 | 5.3929E−01 | −1.1957E+00 | 5.2528E+00 | −1.4996E+01 | 2.5487E+01 | −2.3817E+01 | 9.4708E+00 | 0.0000E+00 | 0.0000E+00 |
| S11 | 8.3151E−02 | −5.6401E−01 | 1.2288E−01 | 1.8122E+00 | −3.6450E+00 | 3.6444E+00 | −2.2317E+00 | 8.2894E−01 | −1.4336E−01 |
| S12 | 2.7729E−01 | −8.8384E−01 | 4.5130E−01 | 1.8400E+00 | −4.6219E+00 | 5.1801E+00 | −3.2206E+00 | 1.0708E+00 | −1.4831E−01 |

As shown in FIG. 2, the optical imaging lens assembly further includes five spacing elements, which are respectively a first spacing element P1, a second spacing element P2, a third spacing element P3, a fourth spacing element P4 and a fifth spacing element P5. The first spacing element P1 is arranged on an image side of the first lens and is at least partially in contact with the image-side surface of the first lens; the second spacing element P2 is arranged on an image side of the second lens and is at least partially in contact with the image-side surface of the second lens; the third spacing element P3 is arranged on an image side of the third lens and is at least partially in contact with the image-side surface of the third lens; the fourth spacing element P4 is arranged on an image side of the fourth lens and is at least partially in contact with the image-side surface of the fourth lens; and the fifth spacing element P5 is arranged on an image side of the fifth lens and is at least partially in contact with the image-side surface of the fifth lens.

### Embodiment 2

FIG. 3 shows a structural schematic diagram of an optical imaging lens assembly according to Embodiment 2 of the disclosure. In the embodiment, for the sake of brevity, some descriptions similar to those in Embodiment 1 will be omitted.

As shown in FIG. 3, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 2 has the same structure as the lens group of the optical imaging lens assembly in Embodiment 1, and basic parameters thereof and a high-order term coefficient table of aspheric surfaces are detailed in Table 1 and Table 2, therefore details are not repeated again.

As shown in FIG. 3, the optical imaging lens assembly further includes five spacing elements, which are respectively a first spacing element P1, a second spacing element P2, a third spacing element P3, a fourth spacing element P4 and a fifth spacing element P5. A difference between the embodiment and Embodiment 1 lies in that at least part of elements in the lens cone and the spacing element group has different structure sizes.

### Embodiment 3

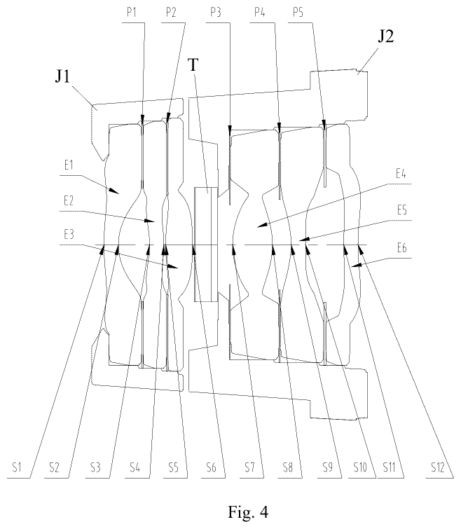

FIG. 4 shows a structural schematic diagram of an optical imaging lens assembly according to Embodiment 3 of the disclosure.

As shown in FIG. 4, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 3 has the same structure as the lens group of the optical imaging lens assembly in Embodiment 1, and basic parameters thereof and a high-order term coefficient table of aspheric surfaces are detailed in Table 1 and Table 2, therefore details are not repeated again.

As shown in FIG. 4, the optical imaging lens assembly further includes five spacing elements, which are respectively a first spacing element P1, a second spacing element P2, a third spacing element P3, a fourth spacing element P4 and a fifth spacing element P5. A difference between the embodiment and Embodiment 1 lies in that at least part of elements in the lens cone and the spacing element group has different structure sizes.

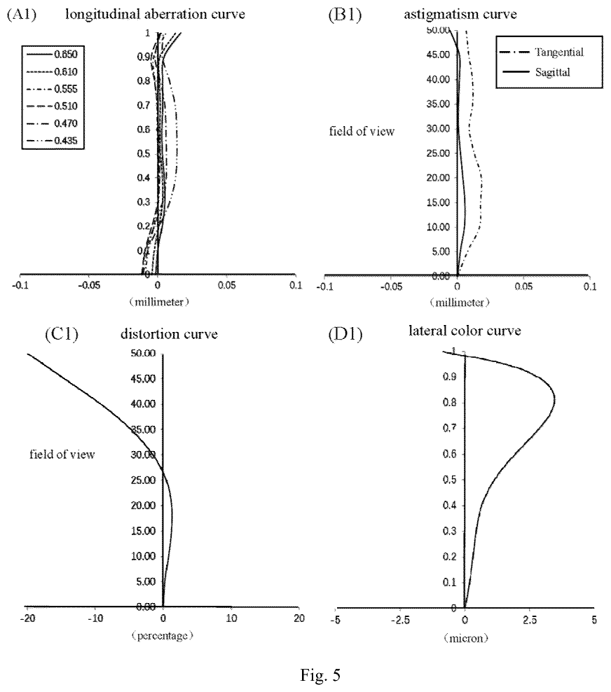

(A1) in FIG. 5 shows a longitudinal aberration curve of the optical imaging lens assemblies in Embodiment 1 to Embodiment 3, which represents deviations of a convergence focal point after lights with different wavelengths pass through the lens. (B1) in FIG. 5 shows an astigmatism curve of the optical imaging lens assemblies in Embodiment 1 to Embodiment 3, which represent a tangential image surface curvature and a sagittal image surface curvature. (C1) in FIG. 5 shows a distortion curve of the optical imaging lens assemblies in Embodiment 1 to Embodiment 3, which represents distortion values corresponding to different angles of field of view. (D1) in FIG. 5 shows a lateral color curve of the optical imaging lens assemblies in Embodiment 1 to Embodiment 3, which represents deviations of different image heights on the imaging surface after lights pass through the lens. According to FIG. 5, the optical imaging lens assemblies in Embodiment 1 to Embodiment 3 are able to achieve good imaging quality.

### Embodiment 4

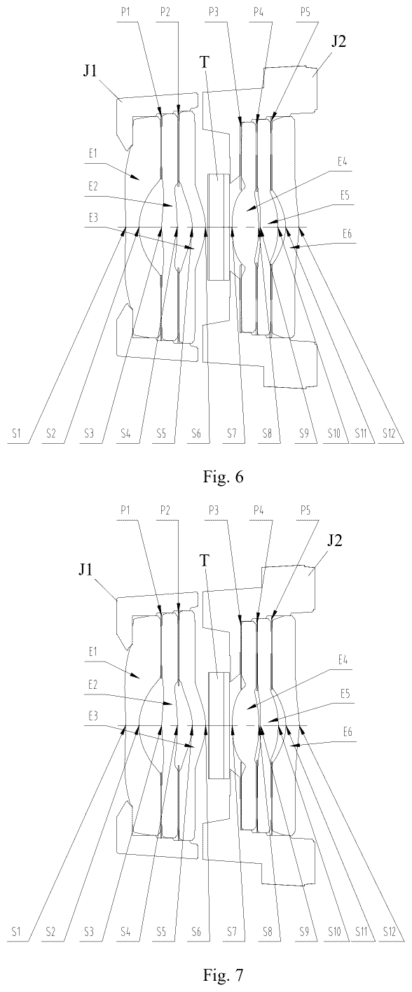

FIG. 6 shows a structural schematic diagram of an optical imaging lens assembly according to Embodiment 4 of the disclosure. As shown in FIG. 6, the optical imaging lens assembly includes a lens cone, a lens group and a spacing element group. The lens cone is a split lens cone, which includes a first lens cone J1 and a second lens cone J2. The lens group of the optical imaging lens assembly sequentially includes from an object side to an image side: a first lens E1, a second lens E2, a third lens E3, a fourth lens E4, a fifth lens E5 and a sixth lens E6. The first lens E1 has an object-side surface S1 and an image-side surface S2. The second lens E2 has an object-side surface S3 and an image-side surface S4. The third lens E3 has an object-side surface S5 and an image-side surface S6. The fourth lens E4 has an object-side surface S7 and an image-side surface S8. The fifth lens E5 has an object-side surface S9 and an image-side surface S10. The sixth lens E6 has an object-side surface S11 and an image-side surface S12.

The optical imaging lens assembly further includes an automatic focusing element T arranged between the third lens E3 and the fourth lens E4. The optical imaging lens assembly further includes a diaphragm STO (not shown) arranged between the third lens E3 and the fourth lens E4, and more specifically, the diaphragm STO is arranged between the automatic focusing element T and the fourth lens E4.

Light from an object sequentially passes through the surfaces S1 to S12 and is finally imaged on an imaging surface (not shown).

Table 3 shows a basic parameter table of the lens group of the optical imaging lens assembly in Embodiment 4, wherein a curvature radius, a thickness/distance and an effective focal length are all in units of millimeters (mm).

TABLE 3

| | | | | Material | | Effective | |
|---|---|---|---|---|---|---|---|
| Surface | Surface | Curvature | Thickness/ | Refractive | Abbe | focal | Conic |
| number | type | radius | distance | index | number | length | coefficient |
| OBJ | Spherical | Infinite | Infinite | | | | |
| S1 | Aspheric | −5.7852 | 0.2500 | 1.54 | 55.71 | −1.56 | −45.3006 |
| S2 | Aspheric | 0.9929 | 0.4273 | | | | −2.5172 |
| S3 | Aspheric | 1.9769 | 0.2940 | 1.55 | 56.09 | 2.50 | −5.5211 |
| S4 | Aspheric | −4.1798 | 0.2810 | | | | −3.6870 |
| S5 | Aspheric | −0.8713 | 0.2500 | 1.68 | 19.24 | −475.09 | −0.0696 |
| S6 | Aspheric | −0.9749 | 0.0477 | | | | −0.5084 |
| T | Spherical | Variable | 0.6300 | | | | |
| STO | Spherical | Infinite | −0.1787 | | | | |
| S7 | Aspheric | 2.0938 | 0.5038 | 1.55 | 56.09 | 2.12 | 4.9959 |
| S8 | Aspheric | −2.3572 | 0.0300 | | | | 0.8382 |
| S9 | Aspheric | −59.1555 | 0.3346 | 1.55 | 56.09 | 2.89 | 5.0000 |
| S10 | Aspheric | −1.5391 | 0.1441 | | | | 2.3124 |
| S11 | Aspheric | −0.7728 | 0.2500 | 1.68 | 19.24 | −2.58 | −0.1075 |
| S12 | Aspheric | −1.5678 | 1.2992 | | | | 0.6732 |

Table 4 shows high-order term coefficients that may be used for the aspheric lens surfaces in Embodiment 4, wherein surface shapes of the aspheric surfaces may be defined by the formula (1) given in Embodiment 1.

TABLE 4

| Surface | | | | | | | | | |
|---|---|---|---|---|---|---|---|---|---|
| number | A4 | A6 | A8 | A10 | A12 | A14 | A16 | A18 | A20 |
| S1 | 9.4877E−02 | −1.0156E−01 | 1.9968E−01 | −2.7644E−01 | 2.4000E−01 | −1.2635E−01 | 3.6783E−02 | −4.5470E−03 | 0.0000E+00 |
| S2 | 1.6688E−01 | −6.9278E−02 | −6.4868E−01 | 3.6911E+00 | −6.1641E+00 | 1.3785E+00 | 1.8117E+01 | −2.2146E+01 | 8.3694E+00 |
| S3 | −2.5190E−01 | −5.2677E−01 | −3.5250E−02 | 4.1450E+00 | −1.2775E+01 | 3.6012E+01 | −6.7757E+01 | 6.4469E+01 | −2.3909E+01 |
| S4 | 6.8701E−02 | −9.5811E−01 | 3.9126E+00 | −1.1412E+01 | 2.8357E+01 | −3.9363E+01 | 2.3159E+01 | −5.9242E−01 | 0.0000E+00 |
| S5 | 9.1310E−01 | −1.7618E+00 | 6.4509E+00 | −1.9485E+01 | 4.7718E+01 | −7.9475E+01 | 8.1419E+01 | −3.8198E+01 | 0.0000E+00 |
| S6 | 6.8004E−01 | −1.4676E+00 | 4.5261E+00 | −1.0992E+01 | 1.8192E+01 | −1.6575E+01 | 8.3199E+00 | −3.7298E+00 | 0.0000E+00 |
| S7 | 3.4337E−01 | −9.0245E−01 | 2.3735E+00 | −2.6026E+00 | 1.2588E+00 | −1.4303E+00 | 4.1020E+00 | 0.0000E+00 | 0.0000E+00 |
| S8 | 3.5112E−01 | −6.3548E+00 | 4.1415E+01 | −1.5119E+02 | 3.4988E+02 | −4.7488E+02 | 2.9669E+02 | 0.0000E+00 | 0.0000E+00 |
| S9 | 2.5177E−01 | −7.5183E+00 | 4.8096E+01 | −2.0720E+02 | 6.6483E+02 | −1.4860E+03 | 1.9844E+03 | −1.1373E+03 | 0.0000E+00 |
| S10 | 2.6909E−01 | −1.5921E+00 | 1.1750E+00 | 3.1135E+01 | −1.8732E+02 | 5.3969E+02 | −8.0834E+02 | 5.2553E+02 | 0.0000E+00 |
| S11 | 1.1042E+00 | −2.3943E+00 | 6.6748E+00 | −1.5745E+01 | 2.0830E+01 | −3.6102E+00 | 1.6632E+01 | 1.8041E+01 | 0.0000E+00 |
| S12 | 7.9331E−01 | −1.2450E+00 | 4.5316E+00 | −1.7900E+01 | 4.3148E+01 | −6.0494E+01 | 4.6090E+01 | −1.4890E+01 | 0.0000E+00 |

As shown in FIG. 6, the optical imaging lens assembly further includes five spacing elements, which are respectively a first spacing element P1, a second spacing element P2, a third spacing element P3, a fourth spacing element P4 and a fifth spacing element P5. The first spacing element P1 is arranged on an image side of the first lens and is at least partially in contact with the image-side surface of the first lens; the second spacing element P2 is arranged on an image side of the second lens and is at least partially in contact with the image-side surface of the second lens; the third spacing element P3 is arranged on an image side of the third lens and is at least partially in contact with the image-side surface of the third lens; the fourth spacing element P4 is arranged on an image side of the fourth lens and is at least partially in contact with the image-side surface of the fourth lens; and the fifth spacing element P5 is arranged on an image side of the fifth lens and is at least partially in contact with the image-side surface of the fifth lens.

### Embodiment 5

FIG. 7 shows a structural schematic diagram of an optical imaging lens assembly according to Embodiment 5 of the disclosure. In the embodiment, for the sake of brevity, some descriptions similar to those in Embodiment 4 will be omitted.

As shown in FIG. 7, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 5 has the same structure as the lens group of the optical imaging lens assembly in Embodiment 4, and basic parameters thereof and a high-order term coefficient table of aspheric surfaces are detailed in Table 3 and Table 4, therefore details are not repeated again.

As shown in FIG. 7, the optical imaging lens assembly further includes five spacing elements, which are respectively a first spacing element P1, a second spacing element P2, a third spacing element P3, a fourth spacing element P4 and a fifth spacing element P5. A difference between the present embodiment and Embodiment 4 lies in that at least part of elements in the lens cone and the spacing element group has different structure sizes.

### Embodiment 6

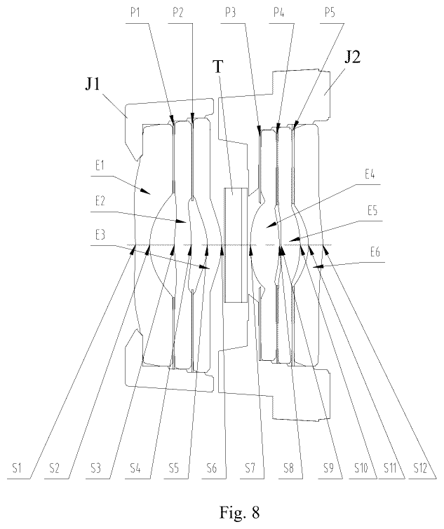

FIG. 8 shows a structural schematic diagram of an optical imaging lens assembly according to Embodiment 6 of the disclosure.

As shown in FIG. 8, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 6 has the same structure as the lens group of the optical imaging lens assembly in Embodiment 4, and basic parameters thereof and a high-order term coefficient table of aspheric surfaces are detailed in Table 3 and Table 4, therefore details are not repeated again.

As shown in FIG. 8, the optical imaging lens assembly further includes five spacing elements, which are respectively a first spacing element P1, a second spacing element P2, a third spacing element P3, a fourth spacing element P4 and a fifth spacing element P5. A difference between the present embodiment and Embodiment 4 lies in that at least part of elements in the lens cone and the spacing element group has different structure sizes.

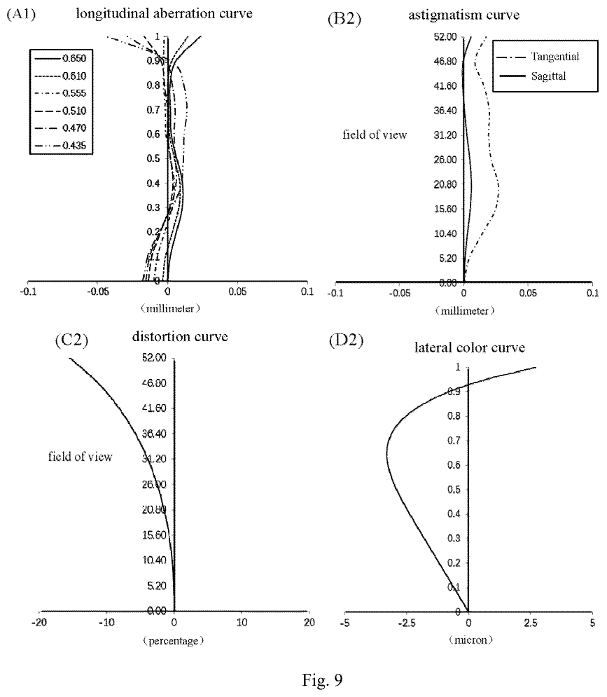

(A2) in FIG. 9 shows a longitudinal aberration curve of the optical imaging lens assemblies in Embodiment 4 to Embodiment 6, which represent deviations of a convergence focal point after lights with different wavelengths pass through the lens. (B2) in FIG. 9 shows an astigmatism curve of the optical imaging lens assemblies in Embodiment 4 to Embodiment 6, which represent a tangential image surface curvature and a sagittal image surface curvature. (C2) in FIG. 9 shows a distortion curve of the optical imaging lens assemblies in Embodiment 4 to Embodiment 6, which represents distortion values corresponding to different angles of field of view. (D2) in FIG. 9 shows a lateral color curve of the optical imaging lens assemblies in Embodiment 4 to Embodiment 6, which represents deviations of different image heights on the imaging surface after lights pass through the lens. According to FIG. 9, the optical imaging lens assemblies in Embodiment 4 to Embodiment 6 are able to achieve good imaging quality.

### Embodiment 7

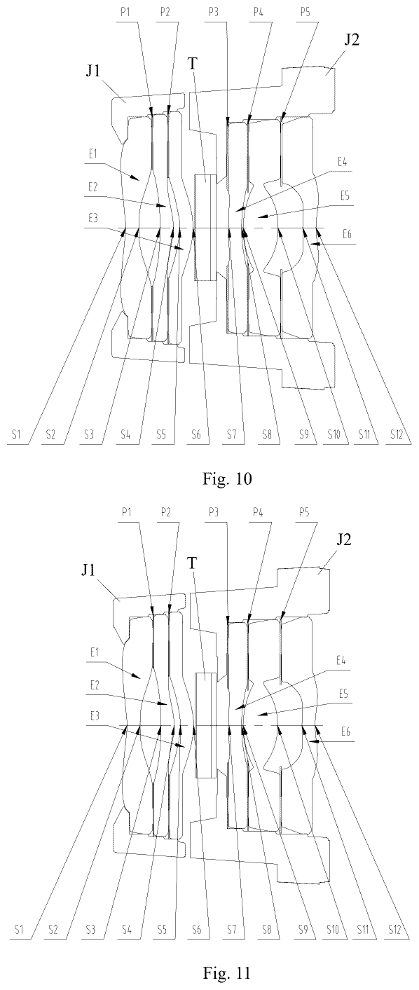

FIG. 10 shows a structural schematic diagram of an optical imaging lens assembly according to Embodiment 7 of the disclosure. As shown in FIG. 10, the optical imaging lens assembly includes a lens cone, a lens group and a spacing element group. The lens cone is a split lens cone, which includes a first lens cone J1 and a second lens cone J2. The lens group of the optical imaging lens assembly sequentially includes from an object side to an image side: a first lens E1, a second lens E2, a third lens E3, a fourth lens E4, a fifth lens E5 and a sixth lens E6. The first lens E1 has an object-side surface S1 and an image-side surface S2. The second lens E2 has an object-side surface S3 and an image-side surface S4. The third lens E3 has an object-side surface S5 and an image-side surface S6. The fourth lens E4 has an object-side surface S7 and an image-side surface S8. The fifth lens E5 has an object-side surface S9 and an image-side surface S10. The sixth lens E6 has an object-side surface S11 and an image-side surface S12.

The optical imaging lens assembly further includes an automatic focusing element T arranged between the third lens E3 and the fourth lens E4. The optical imaging lens assembly further includes a diaphragm STO (not shown) arranged between the third lens E3 and the fourth lens E4, and more specifically, the diaphragm STO is arranged between the automatic focusing element T and the fourth lens E4.

Light from an object sequentially passes through the surfaces S1 to S12 and is finally imaged on an imaging surface (not shown).

Table 5 shows a basic parameter table of the lens group of the optical imaging lens assembly in Embodiment 7, wherein a curvature radius, a thickness/distance and an effective focal length are all in units of millimeters (mm).

TABLE 5

| | | | | Material | | Effective | |
|---|---|---|---|---|---|---|---|
| Surface | Surface | Curvature | Thickness/ | Refractive | Abbe | focal | Conic |
| number | type | radius | distance | index | number | length | coefficient |
| OBJ | Spherical | Infinite | Infinite | | | | |
| S1 | Aspheric | −1.5318 | 0.2500 | 1.55 | 56.09 | −2.13 | −0.2933 |
| S2 | Aspheric | 5.1276 | 0.3997 | | | | −60.4138 |
| S3 | Aspheric | −5.0274 | 0.2500 | 1.55 | 56.09 | 2.48 | 17.2356 |
| S4 | Aspheric | −1.0849 | 0.1210 | | | | −7.6984 |
| S5 | Aspheric | −1.0025 | 0.2500 | 1.64 | 23.52 | −14.69 | −4.4403 |
| S6 | Aspheric | −1.2310 | 0.0319 | | | | −4.2085 |
| T | Spherical | Variable | 0.6300 | | | | |
| STO | Spherical | Infinite | 0.0132 | | | | |
| S7 | Aspheric | −16.1602 | 0.2400 | 1.68 | 19.24 | −4.08 | −99.0005 |
| S8 | Aspheric | 3.3504 | 0.0300 | | | | 16.0841 |
| S9 | Aspheric | 1.3516 | 0.6572 | 1.55 | 56.09 | 1.42 | 0.0792 |
| S10 | Aspheric | −1.5148 | 0.4653 | | | | 0.8784 |
| S11 | Aspheric | 2.2657 | 0.2500 | 1.68 | 19.24 | −5.75 | −98.9999 |
| S12 | Aspheric | 1.3685 | 0.7814 | | | | −3.0635 |

Table 6 shows high-order term coefficients that may be used for the aspheric lens surfaces in Embodiment 7, wherein surface shapes of the aspheric surfaces may be defined by the formula (1) given in Embodiment 1.

TABLE 6

| Surface | | | | | | | | | |
|---|---|---|---|---|---|---|---|---|---|
| number | A4 | A6 | A8 | A10 | A12 | A14 | A16 | A18 | A20 |
| S1 | 9.4310E−01 | −2.0945E+00 | 3.4449E+00 | −3.9267E+00 | 3.0621E+00 | −1.5942E+00 | 5.2902E−01 | −1.0110E−01 | 8.4614E−03 |
| S2 | 9.8315E−01 | −2.4218E+00 | 4.9200E+00 | −1.2306E+01 | 2.6655E+01 | −3.7873E+01 | 3.2017E+01 | −1.4580E+01 | 2.7485E+00 |
| S3 | 5.8202E−02 | −6.7447E−02 | −1.4625E+00 | 5.2784E+00 | 5.2626E+00 | −3.5924E+00 | 1.1616E+01 | −8.9110E+00 | 2.3564E+00 |
| S4 | 3.5943E−01 | −3.6691E−01 | −2.5856E+00 | 1.5526E+01 | −3.8390E+01 | 5.1677E+01 | −3.6931E+01 | 1.0871E+01 | 0.0000E+00 |
| S5 | 1.0601E+00 | −4.8341E+00 | 1.5704E+01 | −3.8128E+01 | 6.0520E+01 | −5.5927E+01 | 2.6272E+01 | −4.5398E+00 | 0.0000E+00 |
| S6 | 4.2215E−01 | −1.9245E+00 | 6.0358E+00 | −1.4194E+01 | 2.1810E+01 | −1.8228E+01 | 6.2016E+00 | 0.0000E+00 | 0.0000E+00 |
| S7 | 5.6603E−01 | −1.6852E+00 | 2.8229E+00 | 1.0051E−02 | −2.8522E+01 | 7.1874E+01 | −6.3815E+01 | 0.0000E+00 | 0.0000E+00 |
| S8 | 6.0104E−02 | 6.7099E−01 | −4.8045E+00 | 2.0702E+01 | −7.3212E+01 | 1.3316E+02 | −9.2068E+01 | 0.0000E+00 | 0.0000E+00 |
| S9 | −5.0732E−01 | 2.2827E+00 | −8.1192E+00 | 2.2192E+01 | −4.6506E+01 | 5.9368E+01 | 3.1022E+01 | 0.0000E+00 | 0.0000E+00 |
| S10 | −3.2697E−01 | 6.3290E−01 | −2.0311E+00 | 9.1081E+00 | −3.0886E+01 | 6.7229E+01 | −8.2801E+01 | 4.4890E+01 | 0.0000E+00 |
| S11 | −2.3169E−01 | −4.8831E+00 | 1.8374E+01 | −1.2194E+01 | −2.2420E+02 | 1.1188E+03 | −2.5248E+03 | 2.8695E+03 | −1.3162E+03 |
| S12 | −7.7099E−01 | 3.1293E−01 | 1.1611E+00 | −8.8744E−01 | −9.8033E+00 | 3.4405E+01 | −5.2077E+01 | 3.9205E+01 | −1.1913E+01 |

As shown in FIG. 10, the optical imaging lens assembly further includes five spacing elements, which are respectively a first spacing element P1, a second spacing element P2, a third spacing element P3, a fourth spacing element P4 and a fifth spacing element P5. The first spacing element P1 is arranged on an image side of the first lens and is at least partially in contact with the image-side surface of the first lens; the second spacing element P2 is arranged on an image side of the second lens and is at least partially in contact with the image-side surface of the second lens; the third spacing element P3 is arranged on an image side of the third lens and is at least partially in contact with the image-side surface of the third lens; the fourth spacing element P4 is arranged on an image side of the fourth lens and is at least partially in contact with the image-side surface of the fourth lens; and the fifth spacing element P5 is arranged on an image side of the fifth lens and is at least partially in contact with the image-side surface of the fifth lens.

### Embodiment 8

FIG. 11 shows a structural schematic diagram of an optical imaging lens assembly according to Embodiment 8 of the disclosure. In the embodiment, for the sake of brevity, some descriptions similar to those in Embodiment 7 will be omitted.

As shown in FIG. 11, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 8 has the same structure as the lens group of the optical imaging lens assembly in Embodiment 7, and basic parameters thereof and a high-order term coefficient table of aspheric surfaces are detailed in Table 5 and Table 6, therefore details are not repeated again.

As shown in FIG. 11, the optical imaging lens assembly further includes five spacing elements, which are respectively a first spacing element P1, a second spacing element P2, a third spacing element P3, a fourth spacing element P4 and a fifth spacing element P5. A difference between the present embodiment and Embodiment 7 lies in that at least part of elements in the lens cone and the spacing element group has different structure sizes.

### Embodiment 9

FIG. 9 shows a structural schematic diagram of an optical imaging lens assembly according to Embodiment 9 of the disclosure.

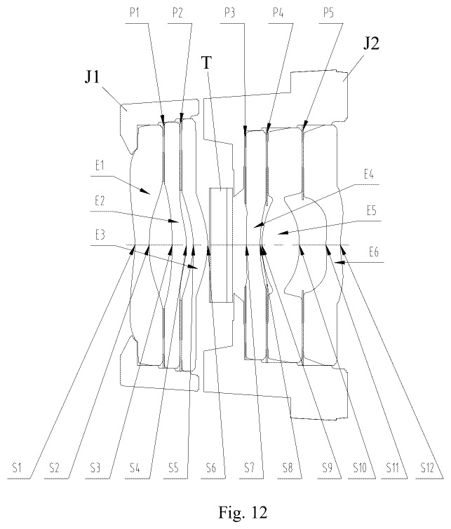

As shown in FIG. 12, the optical imaging lens assembly includes a lens cone, a lens group and a spacing element group. The lens cone is a split lens cone, which includes a first lens cone J1 and a second lens cone J2. The lens group of the optical imaging lens assembly in Embodiment 9 has the same structure as the lens group of the optical imaging lens assembly in Embodiment 7, and basic parameters thereof and a high-order term coefficient table of aspheric surfaces are detailed in Table 5 and Table 6, therefore details are not repeated again.

As shown in FIG. 12, the optical imaging lens assembly further includes five spacing elements, which are respectively a first spacing element P1, a second spacing element P2, a third spacing element P3, a fourth spacing element P4 and a fifth spacing element P5. A difference between the present embodiment and Embodiment 7 lies in that at least part of elements in the lens cone and the spacing element group has different structure sizes.

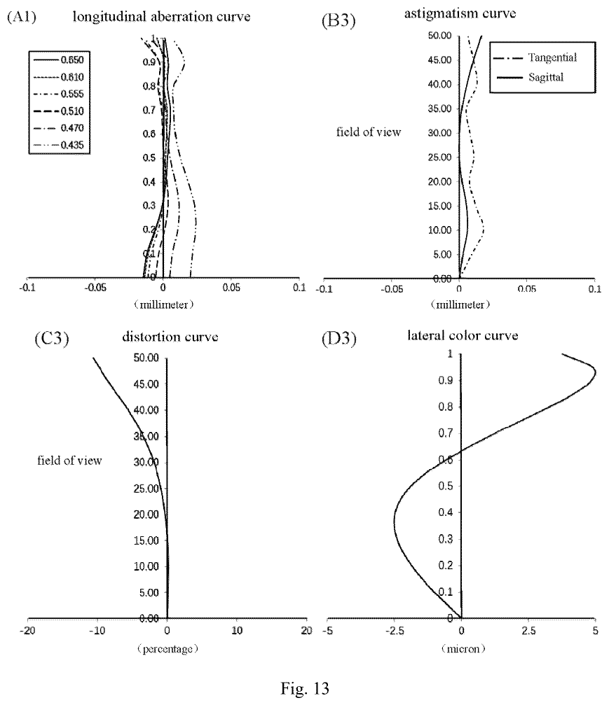

(A3) in FIG. 13 shows a longitudinal aberration curve of the optical imaging lens assemblies in Embodiment 7 to Embodiment 9, which represent deviations of a convergence focal point after lights with different wavelengths pass through the lens. (B3) in FIG. 13 shows an astigmatism curve of the optical imaging lens assemblies in Embodiment 7 to Embodiment 9, which represent a tangential image surface curvature and a sagittal image surface curvature. (C3) in FIG. 13 shows a distortion curve of the optical imaging lens assemblies in Embodiment 7 to Embodiment 9, which represents distortion values corresponding to different angles of field of view. (D3) in FIG. 13 shows a lateral color curve of the optical imaging lens assemblies in Embodiment 7 to Embodiment 9, which represents deviations of different image heights on the imaging surface after lights pass through the lens. According to FIG. 13, the optical imaging lens assemblies in Embodiment 7 to Embodiment 9 are able to achieve good imaging quality.

Table 7 shows parameter values of f, Semi-FOV, SAG52, f45, DT11, DT12, Yc11 and Yc62 of the optical imaging lens assemblies in Embodiment 1 to Embodiment 9. The Semi-FOV is in units of degrees) (°, and other parameters are in units of millimeters (mm).

TABLE 7

| | | | | | | | | | |
|---|---|---|---|---|---|---|---|---|---|
| Parameter/Embodiment | 1 | 2 | 3 | 4 | 5 | 6 | 7 | 8 | 9 |

| | | | |
|---|---|---|---|
| f | 1.83 | 1.70 | 1.70 |
| Semi-FOV | 50 | 52 | 50 |
| DT12 | 0.95 | 0.95 | 0.95 |
| SAG12 | 0.40 | 0.40 | 0.40 |
| SAG51 | −0.14 | −0.14 | −0.14 |
| SAG52 | 0.11 | 0.11 | 0.11 |
| f12 | −2.35 | −2.35 | −2.35 |
| YC11 | 0.78 | 0.78 | 0.78 |

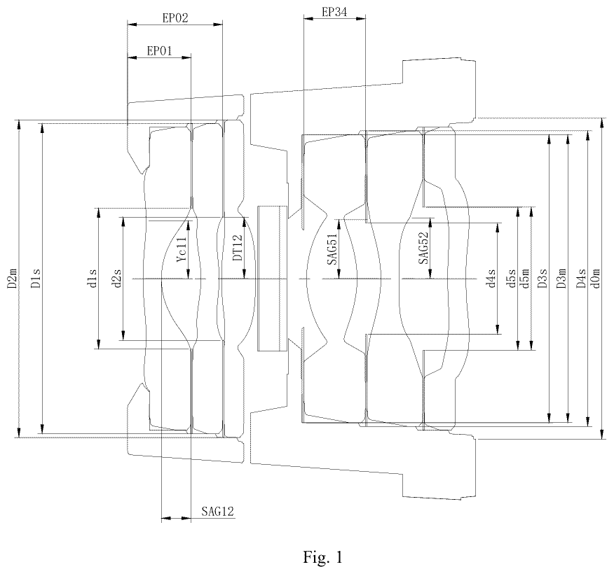

Table 8 shows values of parameters of at least part of elements in the lens cone and the spacing element groups of the optical imaging lens assemblies in Embodiment 1 to Embodiment 9. Some parameters are able to be measured according to a labeling method shown in FIG. 1, and the parameters listed in Table 8 are in units of millimeters (mm).

TABLE 8

| Parameter/Embodiment | 1 | 2 | 3 | 4 | 5 | 6 | 7 | 8 | 9 |
|---|---|---|---|---|---|---|---|---|---|
| d1s | 1.91 | 1.88 | 1.95 | 1.79 | 1.75 | 1.83 | 2.15 | 1.90 | 2.18 |
| D1s | 4.20 | 4.17 | 4.24 | 4.20 | 4.17 | 4.25 | 4.20 | 4.16 | 4.23 |
| d2s | 1.67 | 1.64 | 1.71 | 1.51 | 1.47 | 1.52 | 1.85 | 1.85 | 1.88 |
| D2m | 4.30 | 4.27 | 4.34 | 4.30 | 4.27 | 4.35 | 4.30 | 4.26 | 4.33 |
| D3s | 3.90 | 3.87 | 3.94 | 3.90 | 3.87 | 3.95 | 3.90 | 3.86 | 3.93 |
| D3m | 3.90 | 3.87 | 3.94 | 3.90 | 3.87 | 3.95 | 3.90 | 3.86 | 3.93 |
| d4s | 1.51 | 1.48 | 1.55 | 1.32 | 1.29 | 1.37 | 1.32 | 1.32 | 1.35 |
| D4s | 4.00 | 3.97 | 4.04 | 4.00 | 3.97 | 4.05 | 4.00 | 3.96 | 4.03 |
| d5s | 1.94 | 1.91 | 1.98 | 1.37 | 1.33 | 1.42 | 1.53 | 1.53 | 1.56 |
| d5m | 1.94 | 1.91 | 1.98 | 1.37 | 1.33 | 1.42 | 1.53 | 1.53 | 1.56 |
| d0m | 4.34 | 4.33 | 4.39 | 4.36 | 4.32 | 4.39 | 4.36 | 4.30 | 4.36 |
| EP01 | 0.87 | 0.87 | 0.87 | 0.83 | 0.83 | 0.83 | 0.75 | 0.75 | 0.75 |
| EP34 | 0.85 | 0.85 | 0.85 | 0.28 | 0.29 | 0.27 | 0.36 | 0.37 | 0.36 |
| EP02 | 1.31 | 1.31 | 1.30 | 1.16 | 1.16 | 1.16 | 1.05 | 1.05 | 1.04 |

In summary, the optical imaging lens assemblies in Embodiment 1 to Embodiment 9 satisfy the relationships shown in Table 9.

TABLE 9

| Conditional expression/ | | | | | | | | | |
|---|---|---|---|---|---|---|---|---|---|
| Embodiment | 1 | 2 | 3 | 4 | 5 | 6 | 7 | 8 | 9 |
| R1/f | 2.72 | 2.72 | 2.72 | −3.41 | −3.41 | −3.41 | −0.90 | −0.90 | −0.90 |
| 2 × YC11/d1s | 0.82 | 0.83 | 0.80 | 0.80 | 0.81 | 0.78 | 1.08 | 1.22 | 1.06 |
| EP01/CT1 | 3.47 | 3.48 | 3.46 | 3.33 | 3.34 | 3.32 | 2.99 | 3.01 | 2.99 |
| (D1s-d1s)/DT12 | 2.41 | 2.41 | 2.41 | 2.69 | 2.69 | 2.70 | 1.89 | 2.08 | 1.89 |
| EP34/\|SAG51\| + EP34/\|SAG52\| | 13.95 | 14.05 | 13.90 | 8.01 | 8.21 | 7.84 | 3.48 | 3.63 | 3.54 |
| (D4s/d4s)/(R7/R8) | −2.66 | −2.69 | −2.61 | −3.41 | −3.47 | −3.32 | −0.63 | −0.62 | −0.62 |
| (d0m-d5m)/f5 | −1.08 | −1.08 | −1.08 | 1.03 | 1.03 | 1.03 | 1.98 | 1.95 | 1.97 |
| (d5s-d4s)/\|SAG52\| | 3.90 | 3.90 | 3.90 | 0.30 | 0.30 | 0.30 | 0.81 | 0.81 | 0.81 |
| CT4/EP34 | 0.82 | 0.81 | 0.82 | 1.81 | 1.76 | 1.85 | 0.68 | 0.65 | 0.66 |
| D1s/\|SAG12\| | 10.61 | 10.54 | 10.72 | 10.48 | 10.39 | 10.61 | 18.19 | 17.99 | 18.30 |
| R3/d2s + R5/D3s | 0.14 | 0.14 | 0.15 | 1.09 | 1.12 | 1.08 | −2.97 | −2.98 | −2.93 |
| \|R4/D2m\| + \|R6/D3m\| | 1.82 | 1.83 | 1.80 | 1.22 | 1.23 | 1.21 | 0.57 | 0.57 | 0.56 |
| EP02/T12 | 2.41 | 2.42 | 2.41 | 2.71 | 2.71 | 2.70 | 2.62 | 2.63 | 2.61 |
| \|f12\|/d2s | 1.41 | 1.43 | 1.37 | 6.04 | 6.18 | 5.99 | 7.54 | 7.56 | 7.43 |

The disclosure further provides an imaging apparatus, an electronic photosensitive element thereof is a charge coupled device (CCD) or a complementary metal oxide semiconductor (CMOS). The imaging apparatus is an independent imaging device such as a digital camera, and is also an imaging module integrated on a mobile electronic device such as a mobile phone. The imaging apparatus is equipped with the optical imaging lens assembly described above.

The above description is only illustration of specific embodiments of the disclosure and applied technical principles. It should be understood by those skilled in the art that the protection scope involved in the disclosure is not limited to technical solutions formed by specific combinations of the above technical features, and should also cover other technical solutions formed by any combination of the above technical features or equivalent features thereof without departing from the inventive concept, for example, technical solutions formed by replacing the above features with technical features with similar functions disclosed in the disclosure (but not limited to).

What is claimed is:

1. An optical imaging lens assembly, comprising: a lens cone, and a lens group and a spacing element group, which are arranged in the lens cone,
the lens group sequentially comprises from an object side to an image side along an optical axis:
a first lens with a negative refractive power, wherein an image-side surface thereof is a concave surface;
a second lens with a positive or negative refractive power, wherein an image-side surface thereof is a convex surface;
a third lens with a positive or negative refractive power, wherein an image-side surface thereof is a convex surface;
a fourth lens with a positive or negative refractive power, wherein both an object-side surface and an image-side surface thereof are convex surfaces or concave surfaces;
a fifth lens with a positive or negative refractive power, wherein an image-side surface thereof is a convex surface; and
a sixth lens with a negative refractive power;
the spacing element group comprises a first spacing element, the first spacing element is arranged on an image side of the first lens and is at least partially in contact with the image-side surface of the first lens;
there are six lenses with refractive powers in the optical imaging lens assembly; and
the optical imaging lens assembly satisfies: −3.45<R1/f<2.75 and 0.75<2×Yc11/d1s<1.25, wherein R1 is a curvature radius of an object-side surface of the first lens, f is an effective focal length of the optical imaging lens assembly, Yc11 is a distance from an inflection point that is farthest from the optical axis in an effective diameter of the object-side surface of the first lens to the optical axis, and dis is a maximum inner diameter of an object-side surface of the first spacing element in a direction perpendicular to the optical axis.

2. The optical imaging lens assembly according to claim 1, wherein
the optical imaging lens assembly satisfies: 2.95<EP01/CT1<3.50, wherein EP01 is a distance from an object-side end surface of the lens cone to the object-side surface of the first spacing element along a direction of the optical axis, and CT1 is a center thickness of the first lens on the optical axis.

3. The optical imaging lens assembly according to claim 1, wherein
the optical imaging lens assembly satisfies: 1.85<(D1s−d1s)/DT12<2.75, wherein D1s is a maximum outer diameter of the object-side surface of the first spacing element in the direction perpendicular to the optical axis, and DT12 is a maximum effective radius of the image-side surface of the first lens.

4. The optical imaging lens assembly according to claim 1, wherein,
the spacing element group further comprises a third spacing element and a fourth spacing element, the third spacing element is arranged on an image side of the third lens and is at least partially in contact with the image-side surface of the third lens, and the fourth spacing element is arranged on an image side of the fourth lens and is at least partially in contact with the image-side surface of the fourth lens; and
the optical imaging lens assembly satisfies: 3.45<EP34/|SAG51|+EP34/|SAG52|<14.10, wherein EP34 is a distance from an image-side surface of the third spacing element to an object-side surface of the fourth spacing element along a direction of the optical axis, SAG51 is a distance from an intersection point of an object-side surface of the fifth lens and the optical axis to an effective radius vertex of the object-side surface of the fifth lens on the optical axis, and SAG52 is a distance from an intersection point of the image-side surface of the fifth lens and the optical axis to an effective radius vertex of the image-side surface of the fifth lens on the optical axis.

5. The optical imaging lens assembly according to claim 1, wherein
the spacing element group further comprises a fourth spacing element, the fourth spacing element is arranged on an image side of the fourth lens and is at least partially in contact with the image-side surface of the fourth lens; and
the optical imaging lens assembly satisfies: −3.5<(D4s/d4s)/(R7/R8)<−0.6, wherein D4s is a maximum outer diameter of an object-side surface of the fourth spacing element in the direction perpendicular to the optical axis, d4s is a maximum inner diameter of the object-side surface of the fourth spacing element in the direction perpendicular to the optical axis, R7 is a curvature radius of the object-side surface of the fourth lens, and R8 is a curvature radius of the image-side surface of the fourth lens.

6. The optical imaging lens assembly according to claim 1, wherein
the spacing element group further comprises a fifth spacing element, the fifth spacing element is arranged on an image side of the fifth lens and is at least partially in contact with the image-side surface of the fifth lens; and
the optical imaging lens assembly satisfies: −1.10<(d0m−d5m)/f5<2.00, wherein d0m is a maximum inner diameter of an image-side end surface of the lens cone in the direction perpendicular to the optical axis, d5m is a maximum inner diameter of an image-side surface of the fifth spacing element in the direction perpendicular to the optical axis, and f5 is an effective focal length of the fifth lens.

7. The optical imaging lens assembly according to claim 1, wherein
the spacing element group further comprises a fourth spacing element and a fifth spacing element, the fourth spacing element is arranged on an image side of the fourth lens and is at least partially in contact with the image-side surface of the fourth lens, and the fifth spacing element is arranged on an image side of the fifth lens and is at least partially in contact with the image-side surface of the fifth lens; and
the optical imaging lens assembly satisfies: 0.30≤(d5s−d4s)/|SAG52|≤3.90, wherein d5s is a maximum inner diameter of an object-side surface of the fifth spacing element in the direction perpendicular to the optical axis, d4s is a maximum inner diameter of an object-side surface of the fourth spacing element in the direction perpendicular to the optical axis, and SAG52 is a distance from an intersection point of the image-side surface of the fifth lens and the optical axis to an effective radius vertex of the image-side surface of the fifth lens on the optical axis.

8. The optical imaging lens assembly according to claim 1, wherein
the spacing element group further comprises a third spacing element and a fourth spacing element, the third spacing element is arranged on an image side of the third lens and is at least partially in contact with the image-side surface of the third lens, and the fourth spacing element is arranged on an image side of the fourth lens and is at least partially in contact with the image-side surface of the fourth lens; and
the optical imaging lens assembly satisfies: 0.60<CT4/EP34<1.90, wherein CT4 is a center thickness of the fourth lens on the optical axis, and EP34 is a distance from an image-side surface of the third spacing element to an object-side surface of the fourth spacing element along a direction of the optical axis.

9. The optical imaging lens assembly according to claim 1, wherein
the optical imaging lens assembly satisfies: 10.35<D1s/|SAG12|<18.35, wherein D1s is a maximum outer diameter of the object-side surface of the first spacing element in the direction perpendicular to the optical axis, and SAG12 is a distance from an intersection point of the image-side surface of the first lens and the optical axis to an effective radius vertex of the image-side surface of the first lens on the optical axis.

10. The optical imaging lens assembly according to claim 1, wherein
the spacing element group further comprises a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and
the optical imaging lens assembly satisfies: −3.00<R3/d2s+R5/D3s<1.15, wherein R3 is a curvature radius of an object-side surface of the second lens, R5 is a curvature radius of an object-side surface of the third lens, d2s is a maximum inner diameter of an object-side surface of the second spacing element in the direction perpendicular to the optical axis, and D3s is a maximum outer diameter of an object-side surface of the third spacing element in the direction perpendicular to the optical axis.

11. The optical imaging lens assembly according to claim 1, wherein
the spacing element group further comprises a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and
the optical imaging lens assembly satisfies: 0.55<|R4/D2m|+|R6/D3m|<1.85, wherein R4 is a curvature radius of the image-side surface of the second lens, R6 is a curvature radius of the image-side surface of the third lens, D2m is a maximum outer diameter of an image-side surface of the second spacing element in the direction perpendicular to the optical axis, and D3m is a maximum outer diameter of an image-side surface of the third spacing element in the direction perpendicular to the optical axis.

12. The optical imaging lens assembly according to claim 1, wherein
the spacing element group further comprises a second spacing element, the second spacing element is arranged on an image side of the second lens and is at least partially in contact with the image-side surface of the second lens; and
the optical imaging lens assembly satisfies: 2.40<EP02/T12<2.75, wherein EP02 is a distance from an object-side end surface of the lens cone to an object-side surface of the second spacing element along a direction of the optical axis, and T12 is an air gap between the first lens and the second lens on the optical axis.

13. The optical imaging lens assembly according to claim 1, wherein
the spacing element group further comprises a second spacing element, the second spacing element is arranged on an image side of the second lens and is at least partially in contact with the image-side surface of the second lens; and
the optical imaging lens assembly satisfies: 1.35</f12|/d2s<7.60, wherein f12 is a combined focal length of the first lens and the second lens, and d2s is a maximum inner diameter of an object-side surface of the second spacing element in the direction perpendicular to the optical axis.

14. The optical imaging lens assembly according to claim 1, wherein
the optical imaging lens assembly further comprises an automatic focusing element arranged between the third lens and the fourth lens.

15. An optical imaging lens assembly, comprising: a lens cone, and a lens group and a spacing element group, which are arranged in the lens cone,
the lens group sequentially includes from an object side to an image side along an optical axis:
a first lens with a negative refractive power;
a second lens with a refractive power, wherein an image-side surface thereof is a convex surface;
a third lens with a refractive power, wherein an image-side surface thereof is a convex surface;
a fourth lens with a refractive power, wherein both an object-side surface and an image-side surface thereof are convex surfaces or concave surfaces;
a fifth lens with a refractive power, wherein an image-side surface thereof is a convex surface; and
a sixth lens with a negative refractive power;
the spacing element group comprises a first spacing element; and
the optical imaging lens assembly satisfies: −3.45<R1/f<2.75 and 1.85<(D1s−d1s)/DT12<2.75, wherein R1 is a curvature radius of an object-side surface of the first lens, D1s is a maximum outer diameter of an object-side surface of the first spacing element in a direction perpendicular to the optical axis, d1s is a maximum inner diameter of the object-side surface of the first spacing element in the direction perpendicular to the optical axis, and DT12 is a maximum effective radius of an image-side surface of the first lens.

16. The optical imaging lens assembly according to claim 15, wherein
the optical imaging lens assembly satisfies: 2.95<EP01/CT1<3.50, wherein EP01 is a distance from an object-side end surface of the lens cone to the object-side surface of the first spacing element along a direction of the optical axis, and CT1 is a center thickness of the first lens on the optical axis.

17. The optical imaging lens assembly according to claim 15, wherein
the spacing element group further comprises a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and
the optical imaging lens assembly satisfies: −3.00<R3/d2s+R5/D3s<1.15, wherein R3 is a curvature radius of an object-side surface of the second lens, R5 is a curvature radius of an object-side surface of the third lens, d2s is a maximum inner diameter of an object-side surface of the second spacing element in the direction perpendicular to the optical axis, and D3s is a maximum outer diameter of an object-side surface of the third spacing element in the direction perpendicular to the optical axis.

18. The optical imaging lens assembly according to claim 15, wherein
the spacing element group further comprises a second spacing element and a third spacing element, the second spacing element is arranged on an image side of the second lens and is at least partially in contact with the image-side surface of the second lens, and the third spacing element is arranged on an image side of the third lens and is at least partially in contact with the image-side surface of the third lens; and
the optical imaging lens assembly satisfies: 0.55</R4/D2m|+|R6/D3m|<1.85, wherein R4 is a curvature radius of the image-side surface of the second lens, R6 is a curvature radius of the image-side surface of the third lens, D2m is a maximum outer diameter of an image-side surface of the second spacing element in the direction perpendicular to the optical axis, and D3m is a maximum outer diameter of an image-side surface of the third spacing element in the direction perpendicular to the optical axis.

19. The optical imaging lens assembly according to claim 15, wherein
the spacing element group further comprises a second spacing element, the second spacing element is arranged on an image side of the second lens and is at least partially in contact with the image-side surface of the second lens; and
the optical imaging lens assembly satisfies: 2.40<EP02/T12<2.75, wherein EP02 is a distance from an object-side end surface of the lens cone to an object-side surface of the second spacing element along a direction of the optical axis, and T12 is an air gap between the first lens and the second lens on the optical axis.

20. The optical imaging lens assembly according to claim 15, wherein
the spacing element group further comprises a second spacing element, the second spacing element is arranged on an image side of the second lens and is at least partially in contact with the image-side surface of the second lens; and
the optical imaging lens assembly satisfies: 1.35<|f12|/d2s<7.60, wherein f12 is a combined focal length of the first lens and the second lens, and d2s is a maximum inner diameter of an object-side surface of the second spacing element in the direction perpendicular to the optical axis.
